(19) United States
(12) Patent Application Publication
(10) Pub. No.: US 2011/0277767 A1
(43) Pub. Date: Nov. 17, 2011

(54) METAL ORGANIC FRAMEWORKS (MOFS) FOR AIR PURIFICATION

(75) Inventors: Omar M. Yaghi, Los Angeles, CA (US); David Kyle Britt, Los Angeles, CA (US); David J. Tranchemontagne, Los Angeles, CA (US)

(73) Assignee: THE REGENTS OF THE UNIVERSITY OF CALIFORNIA, Oakland, CA (US)

(21) Appl. No.: 13/140,687

(22) PCT Filed: Dec. 18, 2009
(86) PCT No.: PCT/US09/68849

§ 371 Date: Aug. 2, 2011

Related U.S. Application Data
(60) Provisional application No. 61/138,622, filed on Dec. 18, 2008.

(51) Int. Cl. A62B 7/10; G01J 3/46; B01D 53/02; B01D 53/14; C07F 3/06; C07F 1/08

(52) U.S. Cl. 128/205.27; 556/132; 556/115; 95/90; 95/213; 96/153; 96/290; 356/402

(57) ABSTRACT

This disclosure relates to porous frameworks for gas separation and sensing.

### CROSS REFERENCE TO RELATED APPLICATIONS

This application claims priority under 35 U.S.C. §119 to U.S. Provisional Application Ser. No. 61/138,622, filed Dec. 18, 2008, the disclosure of which is incorporated herein by reference in its entirety.

### STATEMENT REGARDING FEDERALLY SPONSORED RESEARCH

The invention was funded in part by Grant No. W911NF-06-1-0405 awarded by the United States Army, Joint Science and Technology Office. The government has certain rights in the invention.

### FIELD OF THE INVENTION

This disclosure relates to porous frameworks for gas separation, sensing and purification. More particularly, the disclosure relates to porous frameworks for removal of harmful gases from a multi-component gas or fluid.

### BACKGROUND

Release of harmful chemicals into our environment is a growing concern. A number of industrial chemicals produced in excess of a million tons per year worldwide are also highly toxic and can be obtained with relative ease. Effective capture of these chemicals is of great importance both to the protection of the environment and of those who are at risk for being exposed to such materials. General purpose filters consist of activated carbon impregnated with copper, silver, zinc, and molybdenum salts. While such filters have proven to be effective in containing a range of toxic gases, they are not adequately effective against all potential threats. The current applications of activated carbons and any needed improvements on its current performance are largely limited by lack of control over the metrics and functionality of the pores due to the highly amorphous nature of its carbon network. Such obstacles must be overcome if materials are to be developed to address any conceivable harmful chemical.

### SUMMARY

The disclosure provides a porous metal organic framework (MOF) comprising coordinatively unsaturated metal sites or a reactive side group covalently bound to a linking moiety providing a group capable of undergoing reaction to form a covalent, hydrogen, ionic or other bond with an analyte in a fluid for gas separation. In one embodiment, the MOF comprises a replaceable guest species. In another embodiment, the metal organic framework comprises an iso-reticular metal organic framework. In yet another embodiment, the metal in said framework is unsaturated. In a further embodiment, the reactive group comprises a reactive Lewis acid or Lewis base group.

The disclosure also provides a method of separating a harmful gas in a fluid comprising a plurality of gases comprising contacting the porous framework described herein with the fluid, wherein the harmful gas is absorbed or adsorbed to the porous metal organic framework thereby separating the harmful gas from the fluid.

The disclosure also provides a filtration device comprising a porous metal organic framework of the disclosure. The device may be used in various exhaust systems, or in personnel devices such as a gas mask. The filtration device can be a fixed bed absorbent material comprising a MOF of the disclosure.

The disclosure also provides a method of detecting the presence of a harmful gas comprising contacting a porous organic framework of the disclosure with a fluid suspected of containing a harmful gas and measuring a change in optical color or weight (e.g., via acoustics) of the metal organic framework.

The disclosure also provides a filter medium comprising a porous metal organic framework of the disclosure. The MOF may be functionalized to react with certain analytes in a fluid system.

The disclosure also provides a filtration system comprising a gas inlet and an outlet; a metal organic framework (MOF), iso-reticular metal organic framework (IRMOF) or a combination thereof disposed between the inlet and the outlet, wherein the MOF or IRMOF has been functionalized to bind a gas analyte, wherein a fluid comprising a gas analyte enters the inlet and contacts the MOF or IRMOF as it flows towards the outlet, and wherein the fluid is substantially depleted of the gas analyte at the outlet. In one embodiment, the system comprises a fixed bed system. In another embodiment, the fluid flow is a linear flow. In another embodiment, the system comprises a pressure or temperature swing adsorption system.

### BRIEF DESCRIPTION OF THE DRAWINGS

FIG. 1 shows a single crystal x-ray structures of the benchmark MOFs: The Zn₄O(CO₂)₆ cluster linked by terephthalate (MOF-5), 2-aminoterephthalate (IRMOF-3), benzene-1,3,5-tris(4-benzoate) (MOF-177), and diacetylene-1,4-bis-(4-benzoic acid) (IRMOF-62); the Cu₂(CO₂)₄ cluster linked by trimesate (MOF-199); and 1D Zn₂O₂(CO₂)₂ chains linked by 2,5-dihydroxyterephthalate (MOF-74). C atoms, O atoms, N atoms, and metal ions as polyhedral are depicted. H atoms are omitted for clarity. See Table 1 for further structural information.

FIG. 2A-B shows selected kinetic breakthrough curves of gaseous (a) SO₂ and (b) NH₃ contaminants in the benchmark MOFs.

FIG. 3A-D show breakthrough curves of vaporous (a) tetrahydrothiophene, (b) benzene, (c) dichloromethane and (d) ethylene oxide in the benchmark MOFs.

FIG. 4 shows chlorine breakthrough curves.

FIG. 5 shows carbon monoxide breakthrough curves.

FIG. 6 shows apparatus used in the collection of breakthrough data for gaseous (Upper) and vaporous (Lower) challenges.

### DETAILED DESCRIPTION

As used herein and in the appended claims, the singular forms “a,” “and,” and “the” include plural referents unless the context clearly dictates otherwise. Thus, for example, reference to “a species” includes a plurality of such species and reference to “the framework” includes reference to one or more frameworks and equivalents thereof, and so forth.

Unless defined otherwise, all technical and scientific terms used herein have the same meaning as commonly understood to one of ordinary skill in the art to which this disclosure belongs. Although any methods and reagents similar or equivalent to those described herein can be used in the practice of the disclosed methods and compositions, the exemplary methods and materials are now described.

Also, the use of “or” means “and/or” unless stated otherwise. Similarly, “comprise,” “comprises,” “comprising” “include,” “includes,” and “including” are interchangeable and not intended to be limiting.

It is to be further understood that where descriptions of various embodiments use the term “comprising,” those skilled in the art would understand that in some specific instances, an embodiment can be alternatively described using language “consisting essentially of” or “consisting of:”

All publications mentioned herein are incorporated herein by reference in full for the purpose of describing and disclosing the methodologies, which are described in the publications, which might be used in connection with the description herein. The publications discussed above and throughout the text are provided solely for their disclosure prior to the filing date of the present application. Nothing herein is to be construed as an admission that the inventors are not entitled to antedate such disclosure by virtue of prior disclosure.

Removal of harmful gases from the flue exhaust of power plants, currently a major source of anthropogenic carbon dioxide, is commonly accomplished by chilling and pressurizing the exhaust or by passing the fumes through a fluidized bed of aqueous amine solution, both of which are costly and inefficient. In addition, removal of harmful gases in breathing apparatuses is important both for industry and personnel safety in numerous environments including the military and hazardous chemical disposal.

The disclosure provides a filtration/separation column or fixed bed comprising a MOF, IRMOF or a combination thereof capable of separating harmful gases from other gaseous components in a multi-component gas. The retentate can be referred to as being “depleted” of the harmful gas components. While the effluent stream can represent the desired product.

The disclosure includes simple separation systems where a fixed bed of adsorbent is exposed to a linear flow of the gas mixture. This type of setup is referred to as “fixed bed separation.” However, the MOFs can be used for gas separation in more complex systems that include any number of cycles, which are numerous in the chemical engineering literature. Examples of these include pressure swing adsorption (PSA), temperature swing adsorption (TSA), a combination of those two, cycles involving low pressure desorption, and also processes where the MOF material is incorporated into a membrane and used in the numerous membrane-based methods of separation.

Pressure swing adsorption processes rely on the fact that under pressure, gases tend to be attracted to solid surfaces, or “adsorbed”. The higher the pressure, the more gas is adsorbed; when the pressure is reduced, the gas is released, or desorbed. PSA processes can be used to separate gases in a mixture because different gases tend to be attracted to different solid surfaces more or less strongly. If a gas mixture such as air, for example, is passed under pressure through a vessel comprising a MOF or IRMOF of the disclosure that attracts nitrogen more strongly than it does oxygen, part or all of the nitrogen will stay in the bed, and the gas coming out of the vessel will be enriched in oxygen. When the bed reaches the end of its capacity to adsorb nitrogen, it can be regenerated by reducing the pressure, thereby releasing the adsorbed nitrogen. It is then ready for another cycle of producing oxygen enriched air.

Temperature swing adsorption functions similarly, however instead of the pressure being changed, the temperature is changed to adsorb or release the bound analyte. Such systems can also be used with the MOF or IRMOF system of the disclosure.

The disclosure provides an apparatus and method for separating one or more components from a multi-component gas using a separation system (e.g., a fixed-bed system and the like) having a feed side and an effluent side separated by a MOF and/or IRMOF of the disclosure. The MOF and/or IRMOF may comprise a column separation format.

In one embodiment of the disclosure, a gas separation material comprising a MOF and/or IRMOF is provided. Gases that may be stored or separated by the methods, compositions and systems of the disclosure include harmful gas molecules comprising a reactive side group capable of forming a covalent, hydrogen, ionic or other bond with a harmful gas. In one embodiment, the reactive side group undergoes a Lewis acid/base reaction with the corresponding acid/base. Such harmful cases will either contain a reactive pair of electrons or be acceptors of a reactive pair of electrons present on a framework of the disclosure.

As used herein a multi-component fluid refers to a liquid, air or gas. The fluid may be an atmospheric gas, air or may be present in an exhaust or other by-product of a manufacturing process.

The disclosure is particularly suitable for treatment of air or gas emissions containing one or more harmful gases such as, for example, ammonia, ethylene oxide, chlorine, benzene, carbon monoxide, sulfur dioxide, nitrogen oxide, dichloromethane, and tetrahydrothiophene. However, the disclosure is not limited to the foregoing gases, but rather any gas that can undergo reaction with a MOF or IRMOF of the disclosure.

Devices comprising a MOF or IRMOF of the disclosure can be used to separate multi-component gases in a fluid comprising harmful gases. Such devices can be personnel safety devices, or devices found in emissions portions of a car, factory exhaust and the like. The compositions and methods can be used in combination with other gas removal compositions and devices including, for example, activated charcoal and the like.

Another embodiment provided by the methods and compositions of the disclosure comprises a sensor of harmful gas adsorption or absorption. As described more fully below, the disclosure demonstrates that as MOFs and IRMOFs are contacted and interact with harmful gases of the disclosure the MOF and IRMOFs undergo an optically detectable change. This change can be used to measure the presence of a harmful gas or alternatively to measure the saturation of a MOF or IRMOF in a setting (e.g., in a personnel device to determine exposure or risk).

Metal-organic frameworks (MoFs) are a class of crystalline porous materials whose structure is composed of metal-oxide units joined by organic linkers through strong covalent bonds. The flexibility with which these components can be varied has led to an extensive class of MOF structures with ultra-high surface areas, far exceeding those achieved for porous carbons. MOFs exhibit high thermal stability, with decomposition between 350° C. and 400° C. in the case of MOF-5 (Eddaoudi M, et al., Science 295:469-472, 2002), ensuring their applicability across a wise temperature range. The unprecedented surface area and the control with which their pore metrics and functionality can be designed provides limitless potential for their structure to be tailored to carry out a specific application, thus suggesting the possibility of being superior to activated carbons in many applications.

While application of MOFs to high-density gas storage has been studied, virtually no work has been undertaken to measure their capacity for dynamic gas adsorption properties. Equilibrium adsorption does not adequately predict selectivity, as dynamic capacity is influenced strongly by the kinetics of adsorption. The kinetic properties of adsorption in MOFs are largely unexamined. For these reasons it is necessary to calculate the dynamic adsorption capacity, which is defined as the quantity of a gas adsorbed by a material prior to the time at which the concentration of the gas in the effluent stream reaches an arbitrary “breakthrough” value, 5% of the feed concentration. The disclosure demonstrates a series of dynamic adsorption experiments that establish benchmarks for adsorption capacity in MOFs across a range of contaminant gases and vapors. These benchmark adsorption values serve to rate the potential of MOFs as a class of materials and as a base-line for future studies. Furthermore, the values provide insight into what properties of MOFs make them most suited as dynamic adsorption media.

The disclosure demonstrates the viability of functionalizing the organic links of porous metal-organic frameworks to generate functionalized frameworks comprising a reactive group (e.g., a Lewis acid or Lewis base reactive group). Such reactive groups are useful in the removal (e.g., absorption or adsorption) of harmful gases in a fluid environment such as a vapor or air. Organic frameworks of the disclosure have the general structure M-L-M, wherein L is a linking moiety and M are transition metals.

As used herein, a “core” refers to a repeating unit or units found in a framework. Such a framework can comprise a homogenous repeating core or a heterogeneous repeating core structure. A core comprises a transition metal or cluster of transitions metals and a linking moiety. A plurality of cores linked together defines a framework.

The term “cluster” refers to identifiable associations of 2 or more atoms. Such associations are typically established by some type of bond-ionic, covalent, Van der Waals, and the like.

A “linking cluster” refers to a one or more reactive species capable of condensation comprising an atom capable of forming a bond between a linking moiety substructure and a metal group or between a linking moiety and another linking moiety. Examples of such species are selected from the group consisting of a boron, oxygen, carbon, nitrogen, and phosphorous atom. In some embodiments, the linking cluster may comprise one or more different reactive species capable of forming a link with a bridging oxygen atom. For example, a linking cluster can comprise CO₂H, CS₂H, NO₂, SO₃H, Si(OH)₃, Ge(OH)₃, Sn(OH)₃, Si(SH)₄, Ge(SH)₄, Sn(SH)₄, PO_{S}H, AsO₃H, AsO₄H, P(SH)₃, AS(SH)₃, CH(RSH)₂, C(RSH)₃, CH(RNH₂)₂, C(RNH₂)₃, CH(ROH)₂, C(ROH)₃, CH(RCN)₂, C(RCN)₃, CH(SH)₂, C(SH)₃, CH(NH₂)₂, C(NH₂)₃, CH(OH)₂, C(OH)₃, CH(CN)₂, and C(CN)₃, wherein R is an alkyl group having from 1 to 5 carbon atoms, or an aryl group comprising 1 to 2 pheny rings.

A “linking moiety” refers to a mono-dentate or polydentate compound that bind a transition metal or a plurality of transition metals, respectively. Generally a linking moiety comprises a substructure covalently linked to an alkyl or cycloalkyl group, comprising 1 to 20 carbon atoms, an aryl group comprising 1 to 5 phenyl rings, or an alkyl or aryl amine comprising alkyl or cycloalkyl groups having from 1 to 20 carbon atoms or aryl groups comprising 1 to 5 phenyl rings, and in which a linking cluster (e.g., a multidentate function groups) are covalently bound to the substructure. A cycloalkyl or aryl substructure may comprise 1 to 5 rings that comprise either of all carbon or a mixture of carbon with nitrogen, oxygen, sulfur, boron, phosphorus, silicon and/or aluminum atoms making up the ring. Typically the linking moiety will comprise a substructure having one or more carboxylic acid linking clusters covalently attached.

As used herein, a line in a chemical formula with an atom on one end and nothing on the other end means that the formula refers to a chemical fragment that is bonded to another entity on the end without an atom attached. Sometimes for emphasis, a wavy line will intersect the line.

In one embodiment, the linking moiety substructure is selected from any of the following:

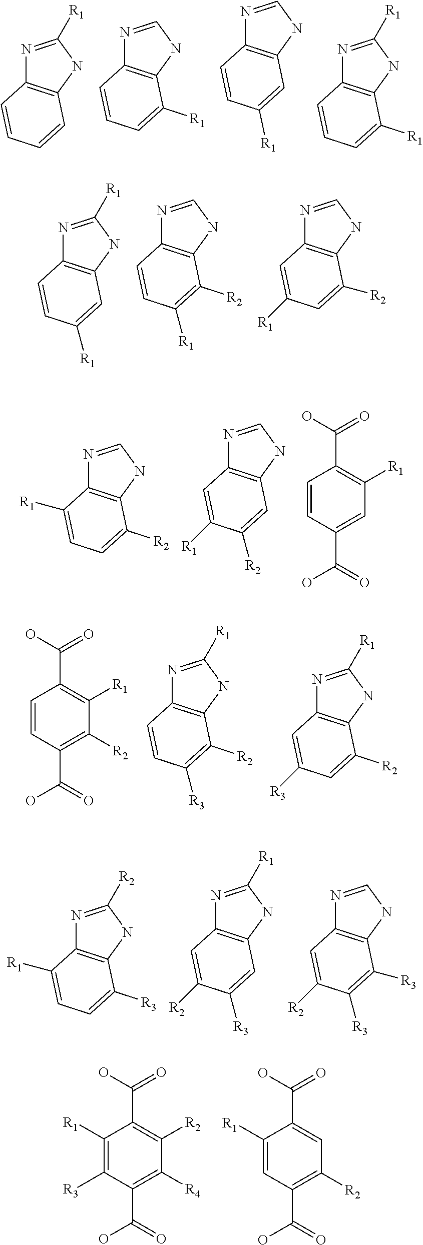

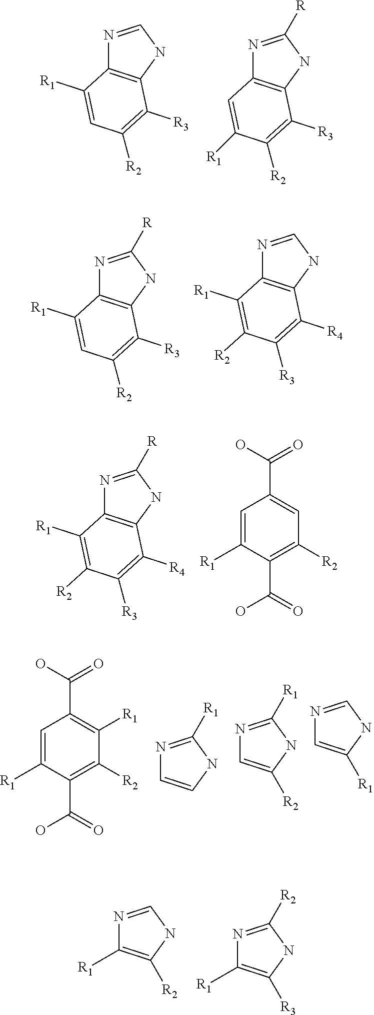

wherein R₁, R₂, R₃, R₄ are individually selected from the group consisting of NH₂, CN, OH, ═O, ═S, SH, P, Br, CL, I, F,

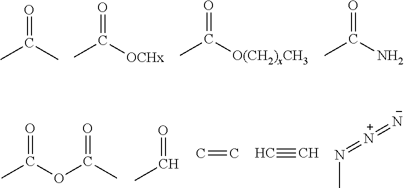

wherein X=1, 2, or 3.

An isoreticular metal-organic framework (IRMOF) according to the disclosure comprises a plurality of secondary building units (SBUs), each of the plurality of SBUs comprises, for example, an M₄O(CO₂)₆ cluster. A compound links adjacent SBUs, the linking compound comprising a linear ditopic carboxylate having at least one phenyl group and at least one functional group X attached to at least one phenyl group. The IRMOF formed has substantial permanent porosity and is very stable, with or without the presence of guest molecules.

M in the SBU is a metal cation. For example, the metal cation can be selected from the group consisting of a beryllium, zinc, cadmium, mercury, and any of the transition metals (in the periodic table, scandium through copper, yttrium through silver, lanthanum through gold, and all known elements from actinium on).

A method of forming an isoreticular metal-organic framework (IRMOF) generally comprises the step of dissolving at least one metal salt and at least one linear ditopic carboxylate in a solvent to form a solution. The solvent may be any suitable solvent such as, for example, any nitrogen containing solvent having a boiling point of less than about 250° C. The solution is then crystallized to form the targeted IRMOF.

In one embodiment, the linear ditopic carboxylate/carboxylic acid has at least one phenyl group. In another embodiment, at least one functional group X is attached to the at least one phenyl group. X may be any suitable functional group as necessary and/or desired.

The crystallizing step is carried out by: leaving the solution at room temperature; adding a diluted base to the solution to initiate the crystallization; diffusing a diluted base into the solution to initiate the crystallization; and/or transferring the solution to a closed vessel and heating to a predetermined temperature.

Particularly the MOF or IRMOF comprises a reactive side group, X, that can bond (either covalently, ionically or through hydrogen bonds with a gas analyte). In one embodiment the reactive side group is a Lewis Acid or base group.

The disclosure demonstrates that coordinatively unsaturated metal sites (e.g., MOF-74 and MOF-199) and amino functionality (e.g., IRMOF-3) prove effective in adsorbing contaminants that interact strongly with those groups. For example, MOF-199 demonstrates efficacy equal to or greater than BPL-carbon against all gases and vapors tested except chlorine. It is particularly effective in removing gases that are vexing for activated carbons such as ammonia and ethylene oxide.

It is clear that a successful MOF-based dynamic adsorption medium will contain some reactive functionality, often in the form of a coordinatively unsaturated metal site. A variety of MOFs with reactive functionality in the pores is known; and there exists immense potential for the development of new MOFs with untested functionalities and metals. Furthermore, the performance of any MOF stands to be improved dramatically once it is impregnated with reactive ions and compounds.

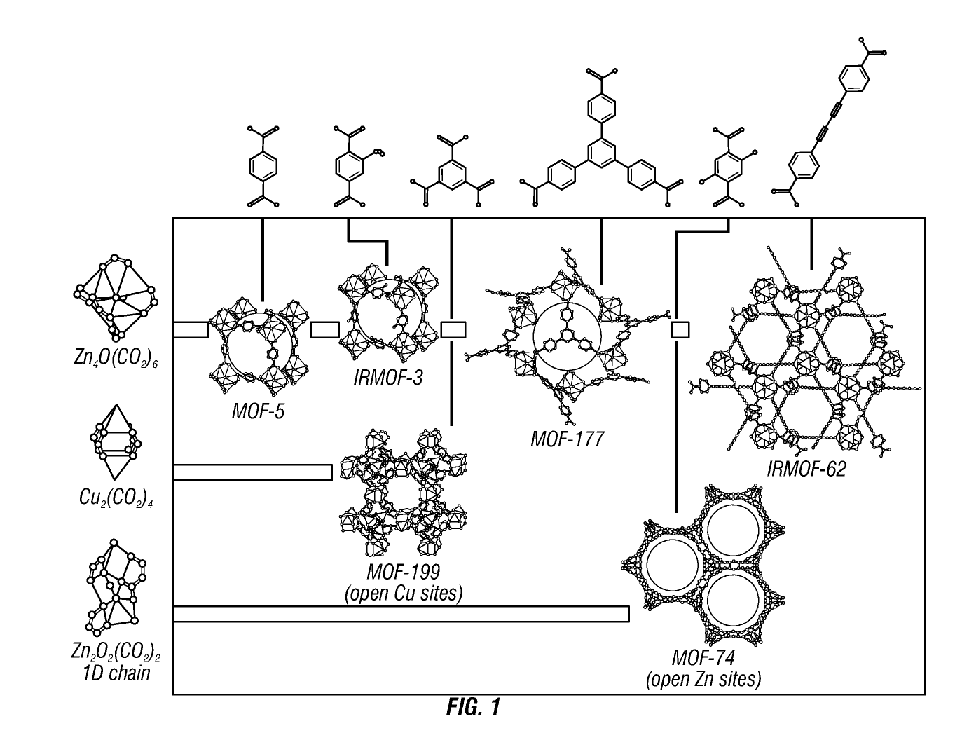

Eight “challenge” gases were selected including several for which activated carbons have poor uptake, such as ammonia and ethylene oxide, as well as several for which they have good uptake, such as chlorine and benzene. Also chosen were carbon monoxide, sulfur dioxide, dichloromethane, and tetrahydrothiophene. Other harmful gases are known in the art and can be assayed for uptake or retention by a MOF or IRMOF of the disclosure using the techniques described herein. A wide range of size, acidity, vapor pressure, and other variables were sampled to span the entire breadth of potential hazards. In a similar manner, an exemplary set of six MOFs (FIG. 1) were chosen to explore a range of surface area, functionality, and pore-dimensions, including MOFs with BET surface area ranging from below 1,000 m²/g to above 4,000 m²/g. Additional MOFs can be generated and tested as described herein. Various functionalities, such as amines, aromatics, and alkynes, coordinatively unsaturated metal sites, and framework catenation were examined, as outlined in Table 1. The dynamic adsorption capacities of the MOFs have been compared in each case to a sample of BPL-carbon, a common undoped activated carbon that is used in various doped forms for many protective applications. An undoped carbon was chosen to establish a frame of reference for the MOFs, which are in themselves undoped. The disclosure demonstrates that for each gas there is a MOF with equal or greater, in some cases far greater, dynamic adsorption capacity than current standard activated carbons. For example, MOF-199 matches or outperforms BPL-carbon for most gases tested.

TABLE 1
Diverse characteristics of the benchmark MOFs

| | SBU* | | Open | Functionalized | | Ultrahigh | Surface | Pore |
|---|---|---|---|---|---|---|---|---|
| MOF | 0D | 1D | metal sites^{†} | pore^{‡} | Catenated^{§} | surface area | area, m²/g^{¶} | volume, cm³/g |
| MOF-5 | ▪ | | | | | ▪ | 2,205 | 1.22 |
| IRMOF-3 | ▪ | | | ▪ | | | 1,568 | 1.07 |
| MOF-74 | | ▪ | ▪ | | | | 632 | 0.39 |
| MOF-177 | ▪ | | | | | ▪ | 3,875 | 1.59 |
| MOF-199 | ▪ | | ▪ | | | | 1,264 | 0.75 |
| IRMOF-62 | ▪ | | | ▪ | ▪ | | 1,814 | 0.99 |

*Secondary building units (SBUs) are either discreet inorganic clusters (0D) or linear chains (1D).
^{†}MOF-74 contains pyramidal 5-coordinate zinc, and MOF-199 contains square 4-coordinate copper.
^{‡}IRMOF-3 contains amino functionality, and IRMOF-62 contains alkyne functionality.
^{§}IRMOF-62 is quadruply interpenetrated.
^{¶}Surface areas calculated by the BET method for samples used in this study. These may differ from reported values as a result of variation in handling and activation procedures.

Many applications involve capture of gaseous compounds from mixtures containing potentially reactive impurities or residual humidity. The effect of impurities present in a particular setting on both the structure of a MOF adsorbent and on the binding affinity of the target adsorbate should be considered in the use of the frameworks. For example, applications pertaining to personal protection depend on the irreversibility of adsorbate binding. The irreversible color change reported for some adsorbate/MOF pairings serves as evidence of irreversibility, which for protective applications is often desirable. However, for other applications such as gas storage, MOFs are known to bind guests reversibly. The results open up a new area of inquiry in the field of metal-organic frameworks and indicate their great potential to supplement and eventually to replace activated carbons as dynamic adsorption media.

### EXAMPLES

Preparation of Mofs. Mofs were Prepared and activated in bulk quantities using modified literature procedures, including those described herein. Each sample was characterized by powder X-ray (Cu Kα) diffraction (PXRD) and N2 adsorption isotherm. Apparent surface areas were determined by the Brunauer, Emmett, and Teller method (BET) and were commensurate with reported values. MOFs were stored under inert atmosphere.

MOF-5: Zn₄O(C₈H₄O₄)₃. Terephthalic acid (3 g, 2×10⁻² mol) and Zn(NO₃)₂.4H₂O (14 g, 5.4×10⁻² mol) were dissolved in 300 mL diethylformamide in a 500 mL jar with sonication. The jar was capped tightly at placed in a 100° C. oven for three days. The mother liquor was decanted and the large yellow crystalline product washed with diethylformamide and then HPLC grade (pentene stabilized) chloroform. The product was immersed in chloroform, which was decanted and replaced with fresh chloroform twice over three days. Product was evacuated to dryness and heated under vacuum to 120° C. for 17 hours. Sample was backfilled and stored under nitrogen. The BET surface area was measured to be 2205 m²/g.

IRMOF-3: Zn₄O(C₈H₅NO₄)₃. 2-aminoterephthalic acid (5.96 g, 3.29×10⁻² mol) and Zn(NO₃)₂.4H₂O (37.47 g, 1.43×10⁻¹ mol) were dissolved in 800 mL diethylformamide in a 1 L jar with sonication. The jar was capped tightly at placed in a 100° C. oven overnight (˜15 hours). The mother liquor was decanted and the large brown crystalline product washed with diethylformamide and then HPLC grade (pentene stabilized) chloroform. The product was immersed in chloroform, which was decanted and replaced with fresh chloroform twice over three days. Product was evacuated to dryness and heated under vacuum to 120° C. for 23 hours. Sample was backfilled and stored under nitrogen. The BET surface area was measured to be 1568 m²/g.

MOF-74: Zn₂(C₈H₂O₆). 2,5-dihydroxyterephthalic acid (1.00 g, 5.05×10⁻³ mol) and Zn(NO₃)₂.4H₂O (4.50 g, 1.72×10⁻² mol) were dissolved in 100 mL dimethylformamide in a 400 mL jar with sonication. 5 mL water was added, followed by additional sonication. The jar was capped tightly and placed in a 110° C. oven for 20 hours. The mother liquor was decanted and the yellow crystalline product washed three times with dimethylformamide, then three times with methanol. The product was immersed in methanol, which was decanted and replaced with fresh methanol three times over four days. Product was evacuated to dryness and heated under vacuum to 150° C. over one hour, held at 150° C. for 10 hours, heated to 265° C. over one hour and held for 12 hours. Sample was backfilled and stored under nitrogen. The BET surface area of the sample was measured to be 632 m²/g.

MOF-177: Zn₄O(C₂₇H₁₅O₆)₂. Benzene-1,3,5-tris-(4-benzoic acid) (2.0 g, 4.6×10⁻³ mol) and Zn(NO₃)₂.4H₂O (7.2 g, 2.8×10⁻² mol) were dissolved in 200 mL diethylformamide in a 500 mL jar. The jar was capped tightly and placed in a 100° C. oven for 24 hours. The mother liquor was decanted and the colorless crystalline product washed with dimethylformamide and immersed in HPLC grade (pentene stabilized) chloroform, which was decanted and replaced with fresh chloroform three times over four days. Solvent was decanted from the product, which was placed in a Schlenk flash. The opening of the flask was cracked slightly to vacuum (just enough to see a pressure change on the Schlenk line) and left for 12 hours. It was then opened slightly more and left for 12 hours. It was then opened fully to vacuum and left for 24 hours at room temperature. Sample was backfilled and stored under nitrogen. The BET surface area of the sample was measured to be 3875 m²/g.

MOF-199: Cu₂(C₉H₃O₆)_{4/3}. Trimesic acid (5.00 g, 2.38×10⁻² mol) and Cu(NO₃)₂.2.5H₂O (10.01 g, 4.457×10⁻² mol) were dissolved in 85 mL dimethylformamide in a 400 mL jar by sonication. 85 mL ethanol was added, followed by sonication. 85 mL water was added, followed by sonication. The jar was capped tightly and placed in a 85° C. oven for 24 hours. Sky blue powdered product was filtered, washed with dimethylformamide and ethanol, and immersed in dichloromethane, which was decanted and replaced with fresh dichloromethane three times over four days. Product was evacuated to dryness and heated under vacuum to 170° C. until color was deep purple (−2 days). Sample was backfilled and stored under nitrogen. The BET surface area of the sample was measured to be 1264 m²/g.

IRMOF-62: Zn₄O(C₁₈H₈O₄)₃. Diacetylene-1,4-bis-(4-benzoic acid) (20.28 g, 6.986×10⁻² mol) and Zn(CH₃CO₂)₂.2H₂O (30.35 g, 1.383×10⁻¹ mol) were stirred in 1.5 L dimethylformamide at room temperature for 10 hours. Off-white powdered product was filtered, washed with dimethylformamide, dichloromethane, and immersed in dichloromethane. The product was filtered, washed with dichloromethane, and immersed in dichloromethane daily for three days. Product was evacuated at room temperature for 18 hours, then at 150° C. for 27 hours. Sample was backfilled and stored under nitrogen. The BET surface area of the sample was measured to be 1814 m²/g.

Breakthrough Testing. A schematic representation of the breakthrough test systems is described herein. Gasses were purchased from Lehner and Martin, Inc, Airgas, and Scott-Marrin, Inc. as certified mixtures in a balance of N₂, Cl₂ at 4%, CO at 1.05%, SO₂ at 1.00% and NH₃ at 0.99%. Flow rate was monitored using a Gilmont rotameter and held at 25 mL/min. Experiments were carried out with the adsorbent at room temperature (25° C.). Detection of the effluent gas from the sample was performed using a Hiden Analytical HPR20 mass spectrometer. Concentrations of N₂, O₂, and the contaminant gas were sampled continuously at a minimum rate of 3 points per minute. The concentration of the contaminant gas was calibrated by comparing to the concentration recorded by the mass spectrometer under unimpeded flow of the source mixture.

Liquid vapors were generated in a balance of nitrogen by a Vici Metronics, Inc. Dynacalibrator model 230 vapor generator, capable of delivering a vapor concentration with ±2% precision. A constant flow rate of 79 mL/min was generated by the vapor generator. The gasses generated for the experiments were mixtures in nitrogen of 64 ppm THT, 1240 ppm Eta, 440 ppm benzene, and 380 ppm methylene chloride. Experiments were carried out with the adsorbent at 25° C. Detection of the effluent gas from the sample was performed using a Thermo-Fisher Antaris IGS Fourier-transform infrared spectrometer. The spectrometer was calibrated for detection of each contaminant vapor using the TQAnalyst software package with a minimum of 16 calibration points across the operating detection range. The concentration of the contaminant vapor was sampled continuously at a minimum rate of 3 points per minute.

All experiments were carried out using a fritted 1.6 cm inner diameter glass sample tube. A bed of MOF 1.0 cm in height (0.4 cm in the case of tetrahydrothiophene tests) was deposited onto the glass frit under inert atmosphere. All samples were purged with ultra-high purity N₂ gas for 20 minutes prior to testing. Testing was carried out with sample cell at room temperature (25° C.).

Dynamic Adsorption Capacity. In each experiment, the “breakthrough concentration” for each contaminant is defined as 5% of the feed concentration. The time at which the concentration of contaminant gas in the effluent surpasses the breakthrough concentration is designated as the “breakthrough time.” The dynamic adsorption capacity is calculated in each case by dividing the total mass of gas adsorbed prior to breakthrough by the mass of adsorbent.

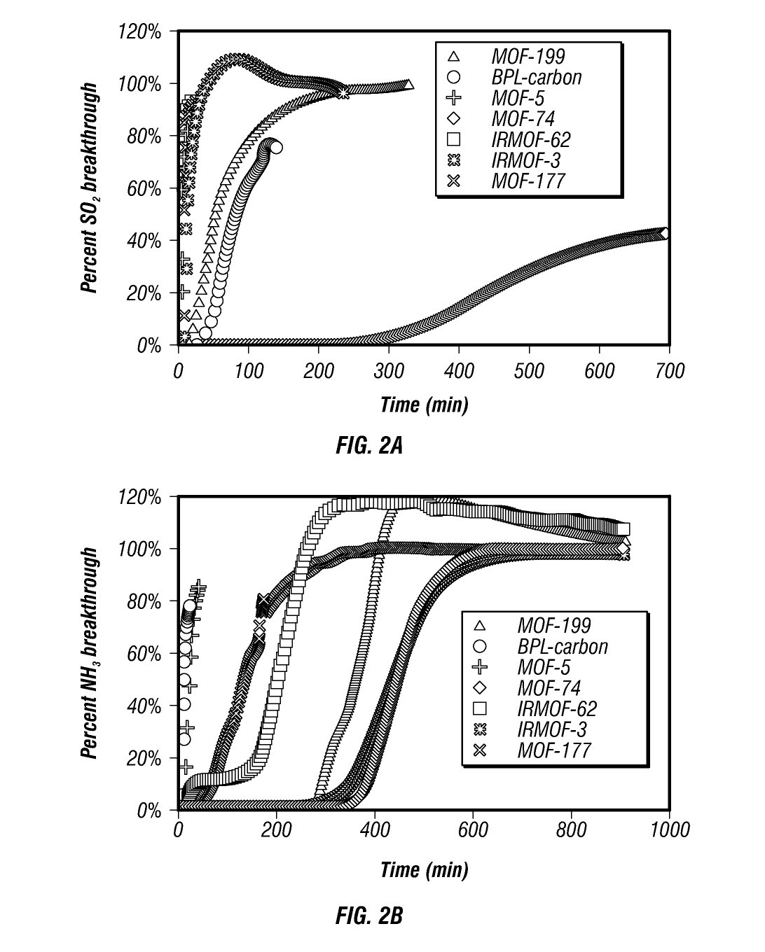

Capture of Gaseous Contaminants. Breakthrough curves for SO₂, NH₃, Cl₂, and CO adsorption in MOF-5, IRMOF-3, IRMOF-62, MOF-74, MOF-177, MOF-199 (the benchmark MOFs), and BPL-carbon were recorded. Selected plots of breakthrough curves and estimated dynamic adsorption capacities for gaseous contaminants are presented in FIG. 2 and Table 2, respectively. No significant retention of CO was observed for any of the materials. Carbon monoxide breakthrough curves do not differ from that measured for a blank sample cell and have been omitted for clarity.

TABLE 2
Dynamic adsorption capacities of the benchmark MOFs for gaseous contaminants measured in grams of gas per gram
of adsorbent

| | | | | | | | | Improvement |
|---|---|---|---|---|---|---|---|---|
| Gas | MOF-5 | IRMOF-3 | MOF-74 | MOF-177 | MOF-199 | IRMOF-62 | BPL carbon | factor* |
| Sulfur dioxide | 0.001 | 0.006 | 0.194^{†} | <0.001 | 0.032 | <0.001 | 0.033 | 5.88 |
| Ammonia | 0.006 | 0.105^{†} | 0.093 | 0.042 | 0.087 | 0.023 | 0.001 | 105 |
| Chlorine | ‡ | 0.335^{†} | ‡ | <0.001 | 0.036 | 0.092 | 0.190 | 1.76 |
| Tetrahydrothiophene | 0.001 | 0.007 | 0.090 | <0.001 | 0.351^{†} | 0.084 | 0.123 | 2.85 |
| Benzene | 0.002 | 0.056 | 0.096 | 0.001 | 0.176^{†} | 0.109 | 0.155 | 1.14 |
| Dichloromethane | <0.001 | 0.001 | 0.032 | <0.001 | 0.055^{†} | 0.019 | 0.053 | 1.04 |
| Ethylene oxide | 0.001 | 0.002 | 0.110 | <0.001 | 0.095^{†} | 0.011 | 0.010 | 9.50 |

*Expresses the ratio of dynamic adsorption capacity of the best-performing MOF (^{†}) to that of BPL carbon.
^{†}Best-performing MOFs.
^{‡}Experiments were not performed because of corrosion of the apparatus by chlorine.

Retention of ammonia in all the benchmark MOFs to was a vast improvement relative to BPL-carbon, three of the MOFs (IRMOF-3, MOF-74, MOF-199) attaining at least 59-fold improvement in dynamic adsorption capacity. However, for the other gases tested MOF-5 and MOF-177 exhibit worse dynamic capacity than BPL-carbon despite having higher surface area than all other materials tested. The lack of reactive functionality paired with the open, highly connected pore structure is therefore thought to make for an ineffective dynamic adsorption medium. Indeed, simply adding an amino functionality to the MOF-5 structure, which results in the IRMOF-3 structure, is sufficient to increase dynamic ammonia capacity more than 18-fold. Though IRMOF-62 has some kinetic adsorption capacity, it too lacks any reactive functionality and is surpassed by BPL-carbon in almost all cases. All three of the aforementioned MOFs had little or no capacity for sulfur dioxide. One MOF to have demonstrated considerable capacity for chlorine gas is IRMOF-62, which is likely the result of the highly reactive nature of the gas. Even in that case, BPL-carbon is the more successful adsorbent. Despite their high capacities for thermodynamic gas adsorption, it is clear that MOFs lacking reactive adsorption sites are ineffective in kinetic gas adsorption.

Coordinatively unsaturated metal sites are known to be reactive as Lewis acids. They demonstrate efficacy as adsorption sites in testing of MOF-199 and MOF-74. MOF-199, which contains an open copper(II) site, outperforms BPL-carbon by a factor of 59 in ammonia adsorption and performs equally well in adsorbing sulfur dioxide. MOF-74 is even more effective, adsorbing more than 62 times the amount of ammonia and nearly 6 times the amount of sulfur dioxide as the activated carbon sample. In both cases, the highly reactive 5-coordinate zinc species in MOF-74 as well as the potentially reactive oxo group, may contribute to the highly successful kinetic adsorption. MOF-199 is less successful when challenged with Cl₂ due to the fact that Cl₂ does not typically act as a ligand. However, MOFs with open metal sites tend to be Lewis acidic and therefore highly effective as adsorption media for gases that can act as Lewis bases, which is a weakness in activated carbons.

While open metal sites are reactive electron deficient groups, amines constitute a common reactive electron rich group that is available for hydrogen bonding as well. As noted above, the presence of the amine in IRMOF-3 affords a vast improvement relative to MOF-5 in adsorption of NH3, a molecule that readily forms hydrogen bonds. Relative to BPL-carbon, IRMOF-3 adsorbs almost 71 times as much ammonia before breakthrough. Furthermore, IRMOF-3 is observed to outperform BPL-carbon by a factor of 1.76 in adsorption of chlorine, against which the open metal site MOFs were ineffective. Clearly it is possible to adsorb a range of contaminants that will react either as Lewis acids or Lewis bases simply by including a reactive functionality of the opposite functionality in a MOF structure.

Some insight into the adsorption mechanism in MOFs can be gleaned by observing changes of color upon adsorption of the contaminants. Activated MOF-199 is deep violet in color. Upon exposure to the atmosphere, its color rapidly changes to light blue because water molecules coordinate to the open copper site. An identical color change is observed upon adsorption of ammonia, indicating that a similar adsorption process is occurring. The color change progresses through the adsorbent bed clearly indicating the progress of the ammonia front. The change is not reversed by prolonged flow of pure nitrogen, indicating that ammonia molecules have chemisorbed to the copper site. Similar color changes are observed upon exposure of MOF-74 to sulfur dioxide, IRMOF-3 to chlorine and ammonia, and IRMOF-62 to chlorine, each of which does not undergo a color change upon exposure to atmosphere. In each case the color change clearly indicates the progression of the contaminant front through the adsorbent bed and is not reversed by pure nitrogen flow. Observation of the adsorption process as a color change in the adsorbent is a possibility for MOFs that does not exist for BPL-carbon. It provides insight into the binding mechanism and gives a clear indication of the extent of saturation of the adsorbent.

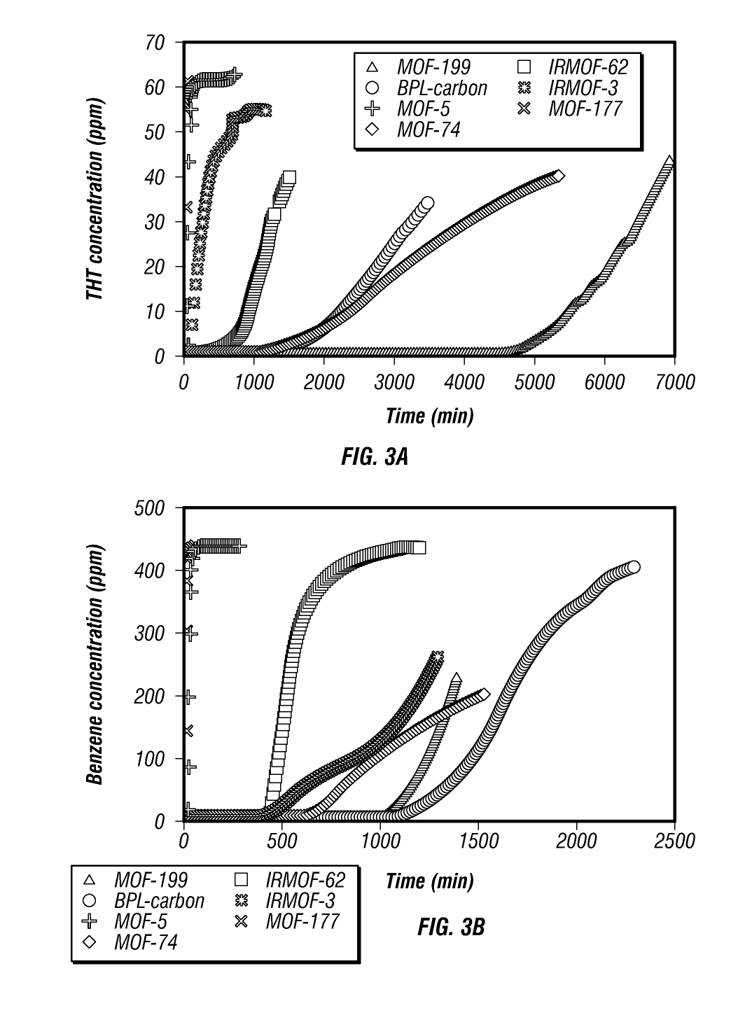

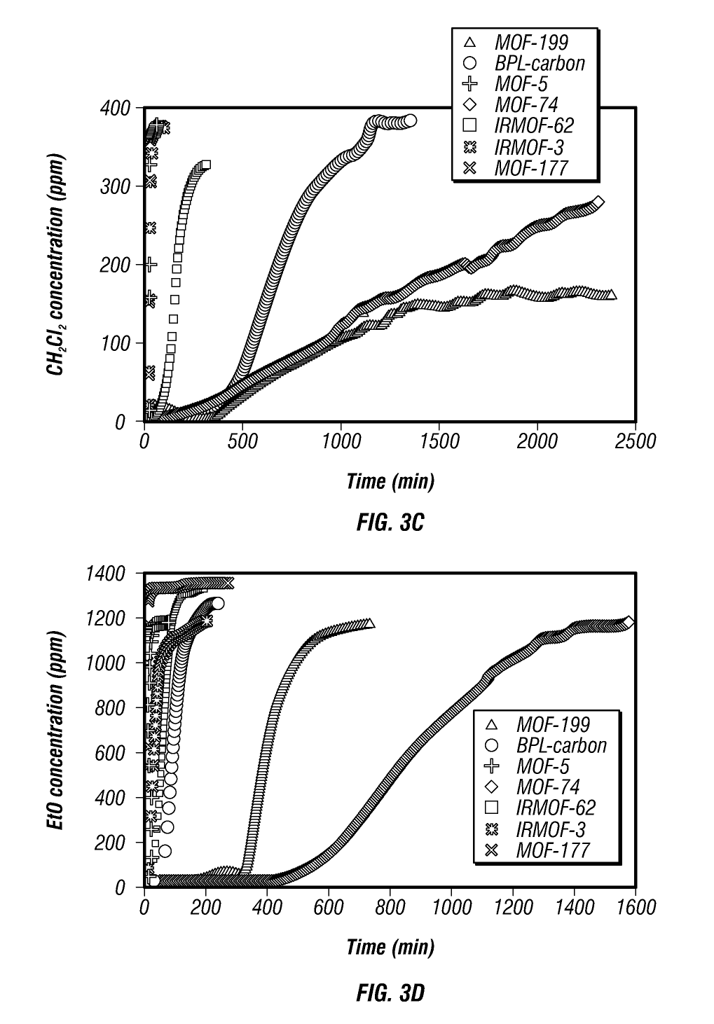

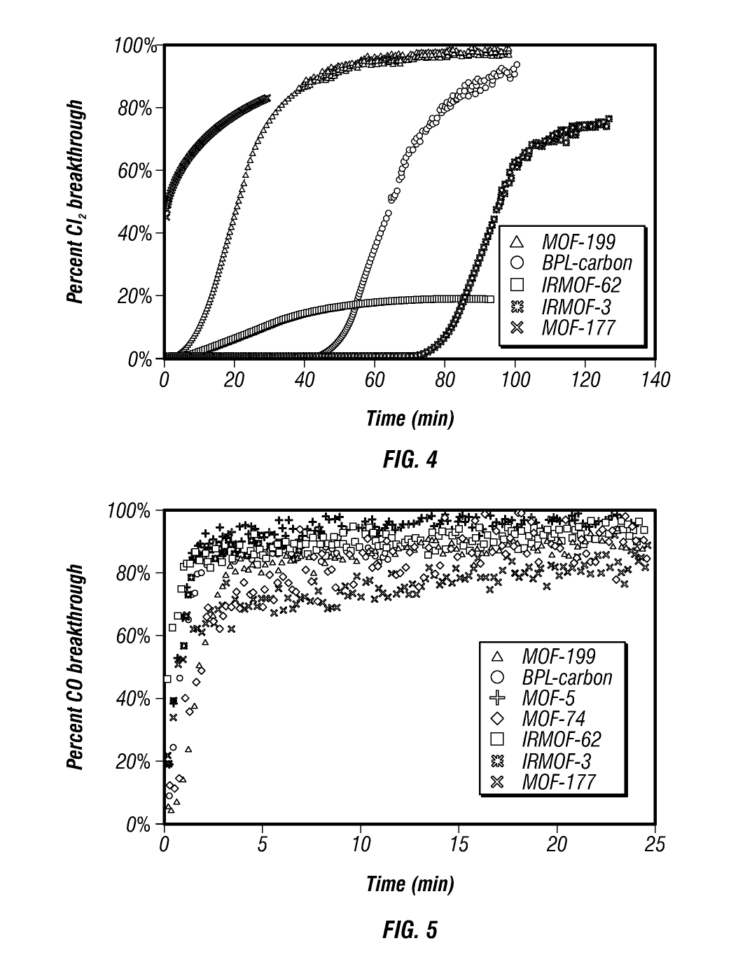

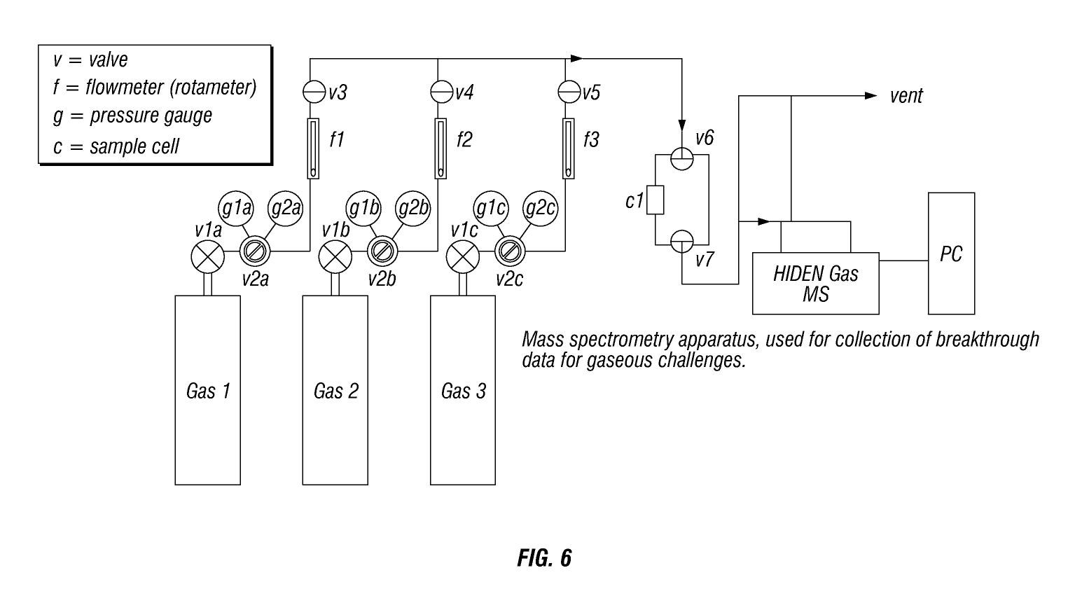

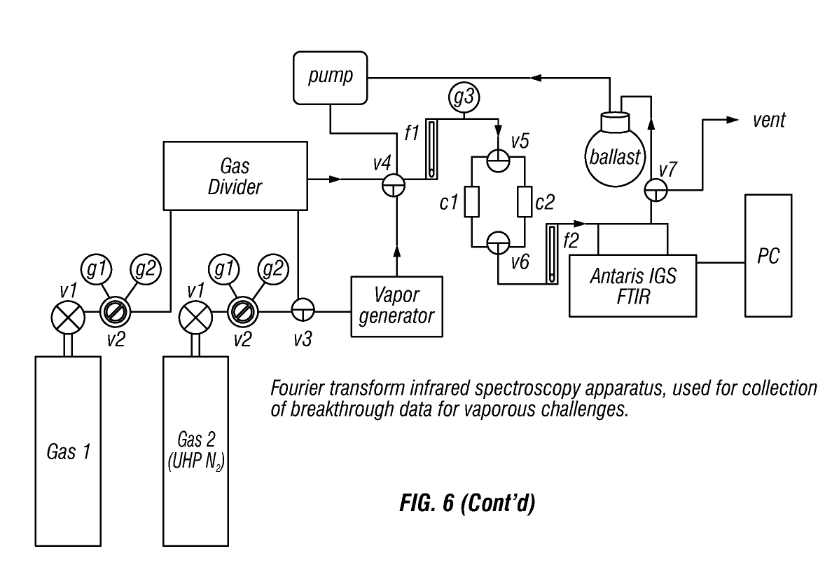

Capture of Vaporous Contaminants. Breakthrough curves for tetrahydrothiophene, benzene, dichloromethane, and ethylene oxide were recorded using the benchmark MOFs and BPL-carbon. Plots of the breakthrough curves and estimated dynamic adsorption capacities for gaseous contaminants are presented in FIG. 3 and Table 2, respectively.

In following with the results of breakthrough experiments on gaseous contaminants, MOF-5 and MOF-177 do not perform well as kinetic adsorption media. IRMOF-62 is also largely outclassed by BPL-carbon except in the case of ethylene oxide adsorption, where IRMOF-62 and BPL-carbon are equally ineffective. IRMOF-3 is a poor adsorbent for the vapors chosen, as none behave as good Lewis acids.

Open metal sites, particularly the copper sites found in MOF-199, prove to be the most effective in removing vapors from the gas stream. Both MOF-74 and MOF-199 outperform BPL-carbon by an order of magnitude. However, MOF-74 is not effective against the entire range of vapors, while MOF-199 is. There is essentially no difference in performance between the activated carbon and MOF-199 in dichloromethane adsorption. There is some improvement over BPL-carbon in benzene adsorption and improvement by nearly a factor of 3 in adsorption of tetrahydrothiophene. In each case except dichloromethane MOF-199 exhibits a color change identical to that observed upon exposure to water or ammonia, again indicating a strong interaction with the open copper site.

1. A porous metal organic framework (MOF) comprising coordinatively unsaturated metal sites or a reactive side group covalently bound to a linking moiety that undergoes reaction to form a covalent, hydrogen, ionic or other bond with an analyte.

2. The porous metal organic framework of claim 1, comprising a replaceable guest species.

3. The porous metal organic framework of claim 1, wherein the metal organic framework comprises an iso-reticular metal organic framework.

4. The porous metal organic framework of claim 1, wherein the metal in said framework is unsaturated.

5. The porous metal organic framework of claim 1, wherein the reactive group comprises a reactive Lewis acid or Lewis base group.

6. A method of separating a harmful gas in a fluid comprising a plurality of gases comprising contacting the porous framework of claim 1 with the fluid, wherein the harmful gas is absorbed or adsorbed to the porous metal organic framework thereby separating the harmful gas from the fluid.

7. A device for removal of a harmful gas comprising a porous metal organic framework of claim 1.

8. The device of claim 7, wherein the device is a personnel device.

9. The device of claim 7, wherein the device is a gas mask.

10. The device of claim 7, wherein the device comprises a fixed bed of adsorbent material or a collective protection unit for a building or facility.

11. A method of detecting the presence of a harmful gas comprising contacting a porous organic framework of claim 1 with a fluid suspected of containing a harmful gas and measuring a change in optical color of the metal organic framework.

12. A filter medium comprising a porous metal organic framework of claim 1.

13. A filter system comprising the filter medium as set forth in claim 12.

14. A filtration system comprising a gas inlet and an outlet; a metal organic framework (MOF), iso-reticular metal organic framework (IRMOF) or a combination thereof disposed between the inlet and the outlet, wherein the MOF or IRMOF has been functionalized to bind a gas analyte, wherein a fluid comprising a gas analyte enters the inlet and contacts the MOF or IRMOF as it flows towards the outlet, and wherein the fluid is substantially depleted of the gas analyte at the outlet.

15. The filtration system of claim 14, wherein the system comprises a fixed bed system.

16. The filtration system of claim 14, wherein fluid flow is a linear flow.

17. The filtration system of claim 14, wherein the system comprises a pressure swing adsorption system.

18. The filtration system of claim 14, wherein the system comprises a temperature swing adsorption system.
